(19) United States
(12) Patent Application Publication
(10) Pub. No.: US 2024/0347745 A1
(43) Pub. Date: Oct. 17, 2024

(54) VEHICLE BATTERY CELL HAVING A HELICAL GAS FLOW PATH

(71) Applicant: NISSAN NORTH AMERICA, INC., Franklin, TN (US)

(72) Inventors: Cenk GUMECI, Northville, MI (US); Sandeep PATIL, Farmington Hills, MI (US)

(21) Appl. No.: 18/300,291

(22) Filed: Apr. 13, 2023

(51) Int. Cl. H01M 8/04082; H01M 4/38; H01M 4/96; H01M 12/08; H01M 50/119; H01M 50/213

(52) U.S. Cl. CPC H01M 8/04201; H01M 4/382; H01M 4/96; H01M 12/08; H01M 50/119; H01M 50/213

(57) ABSTRACT

A battery cell includes an anode, an electrolyte surrounding the anode, a cathode surrounding the electrolyte, and a shell surrounding the cathode. The shell includes a gas inlet and a gas outlet. A gas flow path extends helically from the gas inlet to the gas outlet. The gas flow path is formed between the shell and the cathode.

### BACKGROUND

### Technical Field

The present disclosure generally relates to a battery cell for a vehicle. More specifically, the present disclosure relates to vehicle battery cell having a helical gas flow path.

### Background Information

Theoretically, lithium carbon-dioxide (Li—CO₂) batteries have a significantly higher energy density than lithium-ion and all solid-state batteries. The energy density is the amount of energy a battery cell contains compared to the weight or size of the battery cell. A need exists for a vehicle including a lithium carbon-dioxide battery cell.

### SUMMARY

An object of the present disclosure is to provide a vehicle battery cell having a helical gas flow path.

In view of the state of the known technology, one aspect of the present disclosure is to provide a battery cell including an anode, an electrolyte surrounding the anode, a cathode surrounding the electrolyte, and a shell surrounding the cathode. The shell includes a gas inlet and a gas outlet. A gas flow path extends helically from the gas inlet to the gas outlet. The gas flow path is formed between the shell and the cathode.

Another aspect of the present disclosure is to provide a vehicle door assembly for a vehicle. A battery system comprising a base including a gas feed chamber; and a plurality of battery cells connected to the base, each battery cell including an anode; an electrolyte disposed adjacent the anode; a cathode disposed adjacent to the electrolyte; a shell disposed adjacent to the cathode, the shell including a gas inlet and a gas outlet; and a gas flow path extending helically from the gas inlet to the gas outlet, the gas flow path being formed between the shell and the cathode, the gas flow path being connected to the gas feed chamber.

Also other objects, features, aspects and advantages of the disclosed vehicle door assembly will become apparent to those skilled in the art from the following detailed description, which, taken in conjunction with the annexed drawings, discloses exemplary embodiments of the vehicle door assembly.

### BRIEF DESCRIPTION OF THE DRAWINGS

Referring now to the attached drawings which form a part of this original disclosure:

FIG. 1 is a perspective view of a battery cell in accordance with an exemplary embodiment;

FIG. 2 is a perspective view in cross-section of the battery cell of FIG. 1;

FIG. 3 is an enlarged perspective view in cross-section of the battery cell of FIG. 2;

FIG. 4 is a battery pack including a plurality of the battery cells of FIG. 1;

FIG. 5 is a perspective view in cross-section of the battery pack of FIG. 4 illustrating a gas feed chamber;

FIG. 6 is a perspective view of four interconnected battery cells of FIG. 4;

FIG. 7 is a perspective view of two interconnected battery cells in accordance with another exemplary embodiment;

FIG. 8 is a perspective view in cross-section of the interconnected battery cells of FIG. 7;

FIG. 9 is a schematic diagram of a battery system including first and second tanks;

FIG. 10 is a schematic diagram of a battery system connected to an engine; and

FIG. 11 is a schematic diagram illustrating a discharge operation of the battery cell of FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

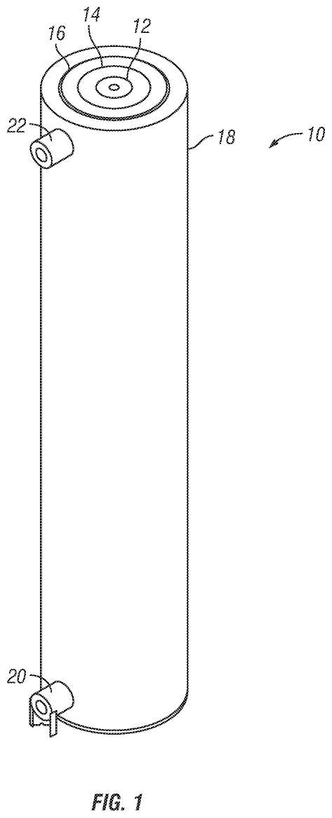

Referring initially to FIGS. 1-3, a battery cell 10 is illustrated in accordance with an exemplary embodiment. The battery cell 10 includes an anode 12, an electrolyte 14 surrounding the anode, a cathode 16 surrounding the electrolyte, and a shell 18 surrounding the cathode. The shell 18 includes a first gas port 20 and a second gas port 22. A gas flow path 24 extends helically between the first gas port 20 and the second gas port 22. The gas flow path 24 is formed between the shell 18 and the cathode 16.

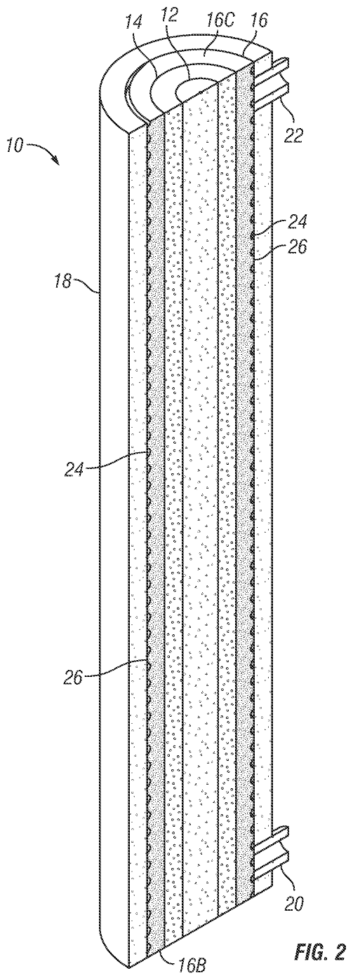

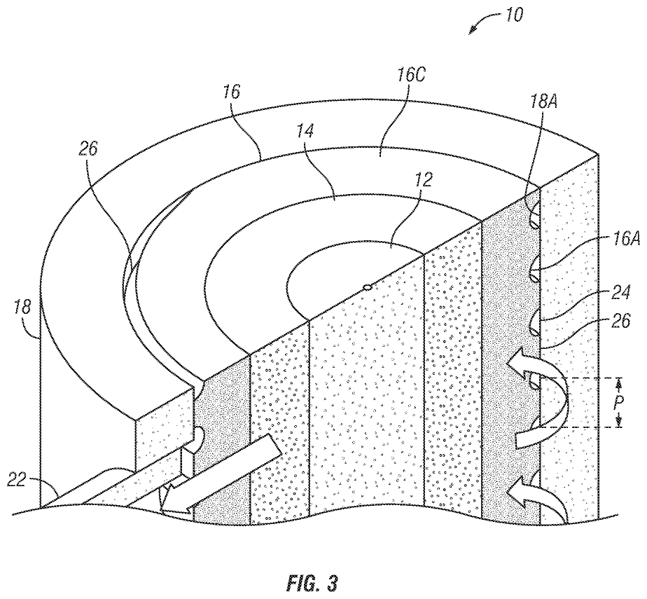

The anode 12 is disposed at an innermost, central portion of the battery cell 10. as shown in FIGS. 2 and 3. The anode 12 is preferably substantially cylindrical. The anode 12 is preferably a lithium anode.

The cathode 16 surrounds the anode 12, as shown in FIGS. 2 and 3. The cathode preferably forms a substantially cylindrical tube. The cathode 16 is preferably a carbon cathode, such as activated carbon, Vulcan XC72, single-walled and multi-walled carbon nanotubes (CNTs), graphene, or carbon aerogel materials. The cathode material can be made of composites of carbon materials listed above and mental nanoparticles of Pt, Cu, Au, Ag. Ir, Mo and Ru as well as alloys of PtAu, PtAg, Cu, CuAg, PtCu, etc. For example, Pt on carbon black (20% weight of Pt), and CuAg on graphene, in which the weight percentages are approximately 1-30% for the metals. The anode 12 and the cathode 16 form the electrodes of the battery cell 10.

The electrolyte 14 is disposed between the anode 12 and the cathode 16. The electrolyte 14 is configured to move charged particles between the anode and the cathode 16 as the battery 10 is charged and discharged. The electrolyte 14 preferably includes an amine dissolved in a battery solvent, and preferably further includes a salt. The electrolyte 14 can be, but is not limited to, ethoxyethanolamine (EEA) in dimethylsulfoxide (DMSO) and LiCLO₄ salt, diisoproylamine (DIPA) in DMSO, DIPA in tetraglyme, or a cyclic amine, such as piperidine and piperazine, in a non-DMSO solvent.

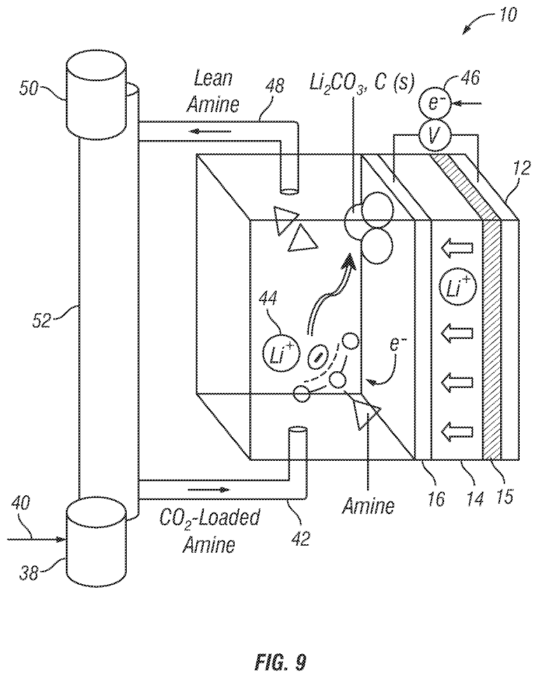

The battery cell 10 includes a separator 15, as shown in FIG. 9. The separator is porous and can be made of polyolefin based materials, such as, but not limited to, polyethylene, polypropylene, and their blends, such as polyethylene-polypropylene with a thickness of approximately 10-30 micrometers.

The shell 18 surrounds the cathode 16, as shown in FIGS. 2 and 3. The shell 18 is preferably a substantially cylindrical tube. The shell 18 is preferably made of a rigid metallic material, such as aluminum. The shell 18 can have any suitable thickness, such as approximately 0.1 mm to approximately 0.3 mm.

As shown in FIGS. 2 and 3, a rib 26 projects outwardly from an outer surface 16A of the cathode 16. The rib 26 extends helically from a first end 16B to a second end 16C of the cathode 16. The gas flow path 24 is helically defined by the outer surface 16A of the cathode 16, the rib 26, and an inner surface 18A of the shell 18. The gas flow path 24 extends continuously from the gas inlet 20 to the gas outlet 22. A pitch P between adjacent ribs 26 forming the helical gas flow path 24 is preferably substantially constant between each pair of adjacent ribs 26. Gas enters the battery cell 10 through the gas inlet 20, flows through the gas flow channel 24 between the cathode 16 and the shell 18, and exits the battery cell 10 through the gas outlet 22. The helical gas flow path 24 increases mass transfer and increases the surface area over which the gas flows.

The first and second gas ports 20 and 22 are preferably aligned in a longitudinal direction of the battery 10, as shown in FIG. 1, although the first and second gas ports 20 and 22 can be disposed in any suitable location. Gas is configured to flow through the gas flow channel 24 in a first direction for a discharge cycle, and to flow through the gas flow channel 24 in a second, and opposite, direction for a charge cycle. During the discharge cycle, the first gas port 20 is a gas inlet, and the second gas port 22 is a gas outlet. During the charge cycle, the second gas port 22 is the gas inlet, and the first gas port 22 is the gas outlet.

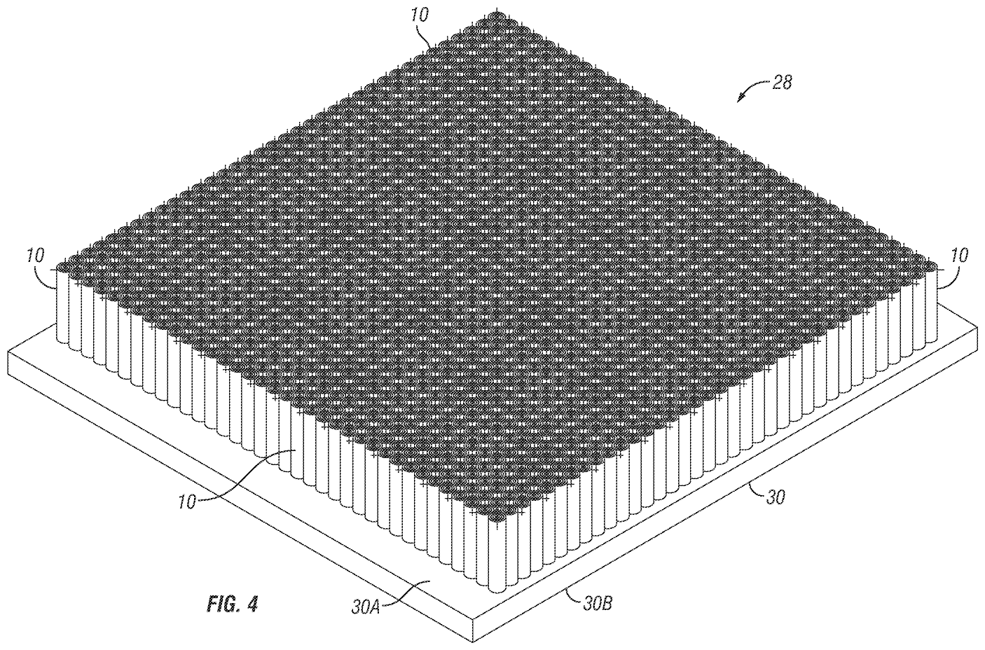

A battery pack 28 includes a plurality of battery cells 10 disposed on a base 30. as shown in FIGS. 4-6. The plurality of battery cells 10 are disposed on an upper surface 30A of the base 30. A gas feed chamber 32 is disposed in the base 30 between the upper surface 30A and a lower surface 30B. The gas feed chamber 32 has a plurality of ports 32A configured to supply gas to and receive gas from the first connecting member 34. The gas feed chamber 32 can have any configuration suitable for supplying gas to the plurality of battery cells 10. A similarly configured base can be disposed above the plurality of battery cells 10 shown in FIG. 4.

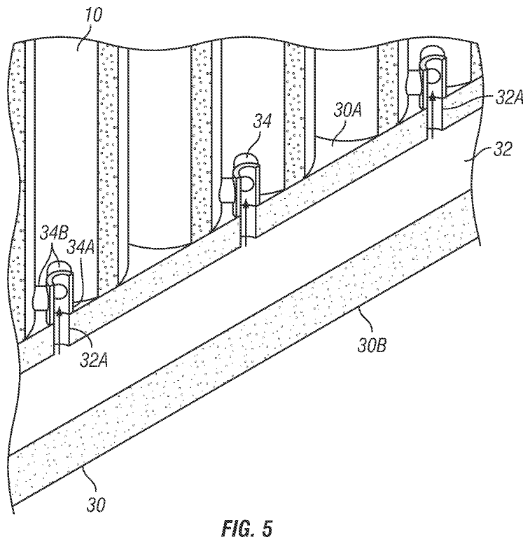

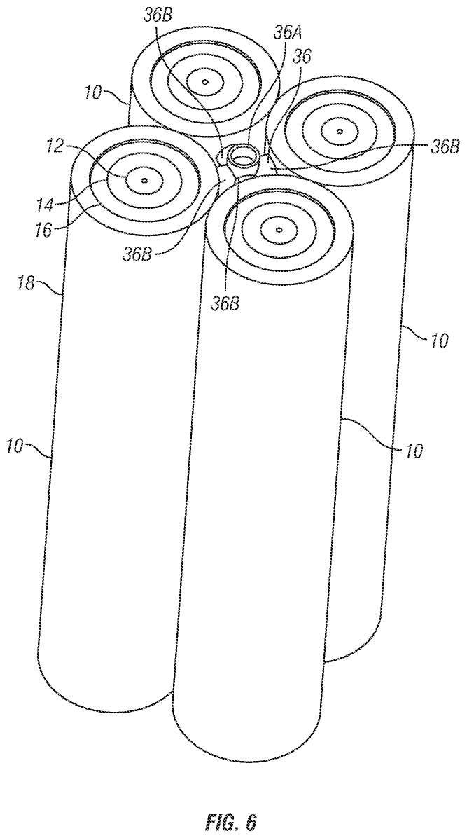

The battery cells 10 of the battery pack 28 are connected by the first connecting member 34 and a second connecting member 36, as shown in FIGS. 5 and 6. The first connecting member 34 includes a first gas port 34A that receives gas from the gas feed chamber 32 in the base 30 of the battery pack 28. The first connecting member 34 includes a plurality of second gas ports 34B. Each of the second gas ports 34B of the first connecting member 34 is connected to a first gas port 20 of a different battery cell 10.

The second connecting member 36 includes a first gas port 36A and a plurality of second gas ports 36B, as shown in FIG. 6. Each of the second gas ports 36B is connected to a second gas port 22 of a different battery cell 10 to facilitate the flow of gas therethrough.

The first connecting member 34 has a second gas port 34B corresponding to each battery cell 10 to which the first connecting member 34 is connected. The second connecting member 36 has a second gas port 36B corresponding to each battery cell 10 to which the second connecting member 36 is connected. As shown in FIG. 6, for example, the second connecting member 36 is connected to four battery cells 10, and has four second gas ports 36B. The first connecting member 34 has four second gas ports 34B corresponding to the four battery cells 10. The first and second connecting members 34 and 36 have the same number of second gas ports 34B and 36B. Each of the first and second connecting members 34 has a single first gas port 34A and 36A, which is either an inlet or outlet for the connecting member based on whether the battery pack is in the charge or discharge cycle. The first and second connecting members 34 and 36 can have any suitable configuration based on the number of battery cells 10 being connected.

A discharge cycle of a lithium-carbon dioxide battery cell 10 in a closed system is illustrated in FIG. 9. An alkyl amine is stored in a first tank 38. Carbon dioxide (CO₂) is supplied to the alkyl amine stored in a first tank 38 as indicated by arrow 40. The capture and uptake of CO₂ by the alkyl amine is rapid, and transfers the supplied CO₂ to a liquid phase. The liquid carbon dioxide solution is stored as either carbamic acid or ammonium carbamate based on the sorbent chemistry. The CO₂ loaded amine adduct is processed through a thermal regeneration unit (not shown), which preferably heats the solution to approximately 90-120 degrees Celsius to release the CO₂ back to a gas phase. The gaseous CO₂ loaded amine adduct is supplied to the battery cell 10 through a pipe 42.

The gaseous CO₂ loaded amine adduct is reduced in the presence of Li⁺ 44 and e⁻ 46 on the cathode 16 via a N—C bond cleavage, as shown in FIG. 9. The battery cell 10 includes a separator 15 disposed between the anode 12 and the cathode 16. The surface area with the cathode 16 is increased by supplying the CO₂ loaded amine adduct through the helical gas flow path 24. The positively charged lithium ions 44 move from the anode 12 to the cathode 16. The chemisorbed CO₂ is converted into lithium carbonate (Li₂CO₃) and carbon (C). The amine is not consumed during the discharge cycle. The amine is regenerated and supplied to the first tank 38 through discharge pipe 48 for further uptake with supplied carbon dioxide. The helical gas flow path 24 increases the surface area of the cathode 16 contacted by the gaseous CO₂ loaded amine adduct, thereby increasing the mass transfer and the surface area. The electrons move from the anode 12 to the cathode 16 to generate electrical power during the discharge cycle.

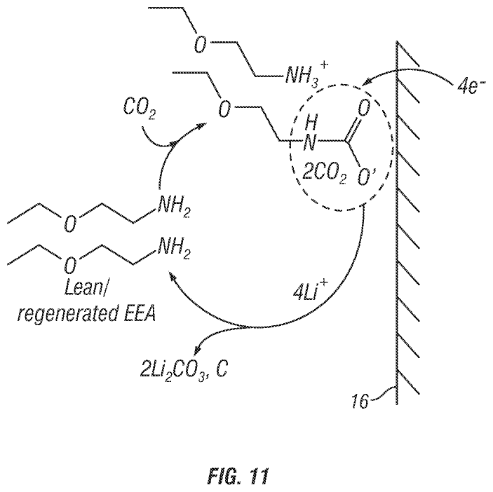

The general equation for the discharge reaction is 4 Li⁺+3CO₂+4e⁻=>2Li₂CO₃+C. With the additional of amines, this equation can be written as RNHCOO⁻+RNH₃⁺+2CO₂+4LI⁺+4e⁻=>2Li₂CO₃+C+2RNH₂, as shown in FIG. 11. During discharge, the lithium-carbon dioxide battery 10 produces lithium carbonate and carbon, using up the supplied carbon dioxide in the process. The lithium carbonate generated during the discharge cycle is stored in a second tank 44. Preferably, the generated lithium carbonate and the carbon are a composite material stored in the second tank 44 for recycling during the charge cycle of the battery cell 10. The capacity of the lithium carbon dioxide battery cell during the discharge cycle can theoretically reach a maximum value of 1879 Wh/Kg (watt-hour per kilogram) and can practically be above 1000 Wh/Kg, or approximately 2000 Wh/L (watt-hour per liter) and can theoretically reach a maximum value of 2460 Wh/L (watt-hour per liter).

The cycle is reversed to recharge the battery cell 10. The general equation for the charge reaction is 2Li₂CO₃+C=>4Li⁺+3CO₂+4e⁻. The equation for the charge reaction with amines can be written as 2Li₂CO₃+C+2RNH₂=>RNHCOO⁻+RNH₃+2CO₂+4Li⁺+4e⁻. The carbon and lithium carbonate generated during the discharge cycle and stored in the second tank 50 are recycled and used during the recharge cycle to charge the battery cell 10.

In the discharge cycle of the battery pack 28, the gaseous CO₂ loaded amine adduct is supplied through pipe 42 to the gas chamber 32, as shown in FIGS. 4 and 5. The gas is supplied to each battery cell 10 from the gas chamber through the plurality of first gas ports 32A. One of the first connectors 34, an inlet feed pipe in the discharge cycle, is fluidly connected to each of the first gas ports 32A in the base 30. The supplied gas flows through the first gas port 34A of the first connector 34, and is supplied to each of the battery cells through a second gas port 34B of the first connector 34. As shown in FIGS. 5 and 6, the first connector 34 has four second gas ports 34B, such that the first connector 34 supplies the gas to four battery cells 10. The gas flows through the helical flow path 24 of each battery cell 10. The generated lithium carbonate and carbon are discharged from each battery cell 10 through the second port 36B of the second connector 36. The first port 36A of the second connector 36 is connected to the pipe 48 (FIG. 9) to supply the generated lithium carbonate and carbon to the second tank 50 for storage.

The lean amine resulting from the discharge cycle is supplied to the first storage tank 38 through pipe 52 to further produce the CO₂ loaded amine with the supplied carbon dioxide indicated by arrow 40.

In the charge cycle of the battery pack 28, generated lithium carbonate and carbon is supplied from the second tank 50 to the battery cell 10 through the second connector 36. The second connector 36 supplies the generated lithium carbonate and carbon to the helical flow path 24 to recharge the battery cell 10. The charge cycle generates carbon dioxide, which is transmitted through the first connector 34 and through the gas chamber 32 to the first storage tank 38 for storage.

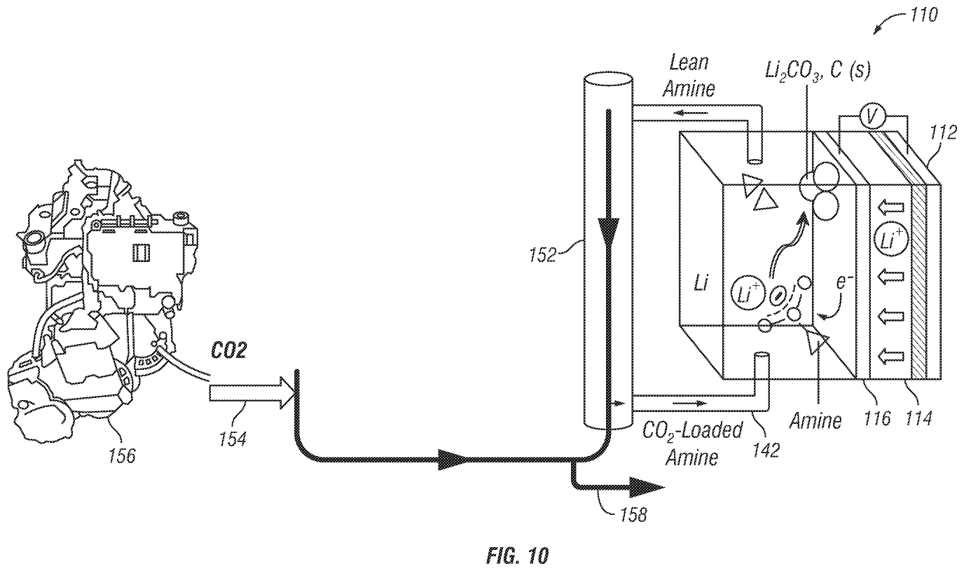

As shown in FIG. 10, a discharge cycle of a lithium-carbon dioxide battery cell 110 in an open system in accordance with another illustrated exemplary embodiment of the present invention is substantially similar to the discharge cycle of the lithium-carbon dioxide battery cell 10 in the open system illustrated in FIG. 9 except for the differences described below. Similar parts are identified with similar reference numerals, except increased by 100 (i.e., 1xx, accordingly).

A discharge cycle of a lithium-carbon dioxide battery cell 110 in an open system is illustrated in FIG. 10. As shown in FIG. 10, the carbon dioxide is supplied to the battery cell 110 from a carbon dioxide supply pipe 154 of an engine 156 of a vehicle. Carbon dioxide from the engine 156 not supplied to the battery cell 110 is exhausted from the supply pipe 154 through an exhaust pipe 158. Lean amine from the battery cell 110 is recirculated and transmitted through the pipe 152 and mixes with the supplied carbon dioxide from the vehicle exhaust 154 to generate the CO₂ loaded amine adduct. The pipe 142 supplies the CO₂ loaded amine adduct to the gas feed chamber 32 (FIG. 5). The gas feed chamber 32 (FIG. 5) is connected to the exhaust pipe 154 of the vehicle to supply the carbon dioxide to the gas feed chamber.

The battery cell 110, including the anode 112, the electrolyte 114 and the cathode 116 is configured substantially similarly to the battery cell 10.

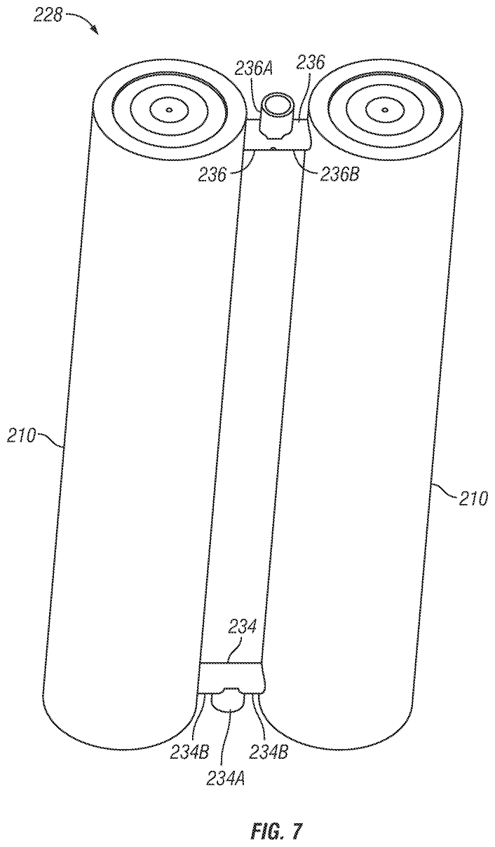

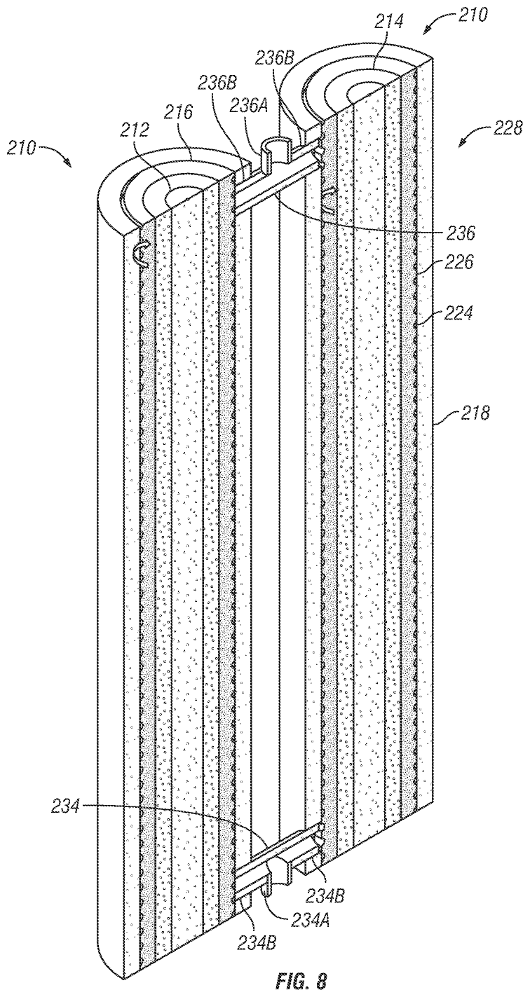

As shown in FIGS. 7 and 8, a battery pack 228 configuration in accordance with another illustrated exemplary embodiment of the present invention is substantially similar to the battery pack configuration illustrated in FIGS. 1 to 6, 9 and 11 except for the differences described below. Similar parts are identified with similar reference numerals, except increased by 200 (i.e., 2xx, accordingly).

The first and second connectors 234 and 236 are configured to be connected to two battery cells 210, as shown in FIGS. 7 and 8. The first connector 234 has a first port 234A and two second ports 234B. The second ports 234B are oppositely disposed with respect to the first port 234A. Each of the second ports 234B is connected to a different battery cell 210.

The second connector 236 has a first port 236A and two second ports 236B. The second ports 236B are oppositely disposed with respect to the first port 236A. Each of the second ports 236B is connected to a different battery cell 210.

The battery cells 210, including the anode 212, the electrolyte 214, the cathode 216, the shell 218, the helical gas flow path 224 and the rib 216, are substantially similar to the battery cell 10 of FIGS. 1-6, 9 and 11.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle battery cell having a helical gas flow path. Accordingly, these terms, as utilized to describe the present invention should be interpreted relative to a vehicle equipped with the vehicle battery cell having a helical gas flow path.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A battery cell comprising:
an anode;
an electrolyte surrounding the anode;
a cathode surrounding the electrolyte;
a shell surrounding the cathode, the shell including a gas inlet and a gas outlet; and
a gas flow path extending helically from the gas inlet to the gas outlet, the gas flow path being formed between the shell and the cathode.

2. The battery cell according to claim 1, wherein
the cathode is a substantially cylindrical tube.

3. The battery cell according to claim 2, wherein
a rib projects outwardly from an outer surface of the cathode, the rib extending helically from a first end to a second end of the cathode.

4. The battery cell according to claim 3, wherein
the gas flow path is defined by the outer surface of the cathode, the rib and the inner surface of the shell.

5. The battery cell according to claim 1, wherein
the shell is made of aluminum.

6. The battery cell according to claim 1, wherein
the cathode is made of carbon.

7. The battery cell according to claim 1, wherein
the anode is made of lithium.

8. The battery cell according to claim 1, wherein
the electrolyte includes an amine dissolved in a battery solvent.

9. The battery cell according to claim 8, wherein
the electrolyte includes a salt.

10. A battery system comprising:
a base including a gas feed chamber; and
a plurality of battery cells connected to the base, each battery cell including
an anode;
an electrolyte disposed adjacent the anode;
a cathode disposed adjacent to the electrolyte;
a shell disposed adjacent to the cathode, the shell including a gas inlet and a gas outlet; and
a gas flow path extending helically from the gas inlet to the gas outlet, the gas flow path being formed between the shell and the cathode, the gas flow path being connected to the gas feed chamber.

11. The battery system according to claim 10, wherein
an inlet feed pipe is connected to the gas feed chamber.

12. The battery system according to claim 11, wherein
the inlet feed pipe is connected to the gas inlet of two battery cells.

13. The battery system according to claim 11, wherein
the inlet feed pipe is connected to the gas inlet of four battery cells.

14. The battery system according to claim 10, wherein
the gas feed chamber is connected to an exhaust pipe of a vehicle to supply carbon dioxide to the gas feed chamber.

15. The battery system according to claim 10, wherein
a first tank is connected to the gas feed chamber to supply gas to the gas feed chamber.

16. The battery system according to claim 10, wherein
a second tank is connected to the gas outlets of the plurality of battery cells.

17. The battery cell according to claim 10, wherein
a rib projects outwardly from an outer surface of the cathode, the rib extending helically from a first end to a second end of the cathode, the gas flow path being defined by the outer surface of the cathode, the rib and the inner surface of the shell.

18. The battery cell according to claim 10, wherein
the cathode is made of carbon.

19. The battery cell according to claim 10, wherein
the electrolyte includes an amine dissolved in a battery solvent.

20. The battery cell according to claim 19, wherein
the electrolyte includes a salt.
